(19) United States
(12) Patent Application Publication
(10) Pub. No.: US 2023/0169404 A1
(43) Pub. Date: Jun. 1, 2023

(54) LEARNING DATA COLLECTING SYSTEM, METHOD OF COLLECTING LEARNING DATA, AND ESTIMATING DEVICE

(71) Applicant: Furuno Electric Co., Ltd., Nishinomiya (JP)

(72) Inventors: Masaya NOSE, Nishinomiya (JP); Hiraku NAKAMURA, Tokyo (JP)

(21) Appl. No.: 18/153,976

(22) Filed: Jan. 12, 2023

Related U.S. Application Data
(63) Continuation-in-part of application No. PCT/JP2021/022279, filed on Jun. 11, 2021.

(30) Foreign Application Priority Data
Jul. 13, 2020 (JP) 2020-119810

(51) Int. Cl. G06N 20/00

(52) U.S. Cl. CPC G06N 20/00

(57) ABSTRACT

The present disclosure provides a learning data collecting system which is easy to collect learning data. The learning data collecting system includes a radar, a communication device, and processing circuitry. The radar receives a reflection wave of a radio wave transmitted around a ship and generates echo data associated with a direction. The communication device receives travel data of an other ship containing position data of the other ship. The processing circuitry extracts, from the echo data, partial echo data of an area corresponding to the position data.

### CROSS-REFERENCE TO RELATED APPLICATION

The present application is a continuation in part of PCT/JP2021/022279, filed on Jun. 11, 2021, and is related to and claims priority to Japanese patent application no. 2020-119810, filed on Jul. 13, 2020. The entire contents of the aforementioned applications are hereby incorporated by reference herein.

### TECHNICAL FIELD

The present disclosure relates to a learning data collecting system, a method of collecting learning data, a data collecting device, a program, a method of generating a machine learning model, a learning device, and an estimating device.

### BACKGROUND ART

Patent Document 1 discloses a method including extracting ship candidate area image from a SAR image, generating a binary image by binarizing the ship candidate area image, generating an evaluation image by synthesizing the binary image and the ship candidate area image, and examining carefully a ship detection result based on the evaluation image.

### REFERENCE DOCUMENT(S) OF CONVENTIONAL ART

### Patent Document

Patent Document 1 JP2019-175142A

### DESCRIPTION OF THE DISCLOSURE

### Problem(s) to be Solved by the Disclosure

Meanwhile, in order to realize an AI system which detects and identifies a target object from echo data generated by a radar, a large amount of learning data is required, and it is difficult to perform annotation manually.

The present disclosure is made in view of the above-described problem, and a primary purpose thereof is to provide a learning data collecting system, a method of collecting learning data, a data collecting device, a program, a method of generating a machine learning model, a learning device, and an estimating device, which are easy to collect the learning data.

### Means for Solving the Problem(s)

In order to solve the problem described above, a learning data collecting system according to one aspect of the present disclosure includes a positioning device, a radar, a communication device, and a partially extracting part. The positioning device generates position data of a ship. The radar receives a reflection wave of a radio wave transmitted around the ship and generates echo data associated with a direction. The communication device receives travel data of an other ship containing position data of the other ship. The partially extracting part extracts, from the echo data, partial echo data of an area corresponding to the position data of the another ship based on the position data of the ship and the position data of the another ship.

Further, a method of collecting learning data according to another aspect of the present disclosure includes generating, by a positioning device, position data of a ship, receiving, by a radar, a reflection wave of a radio wave transmitted around the ship, and generating, by the radar, echo data associated with a direction, receiving, by a communication device, travel data of an other ship containing position data of the other ship, and extracting, from the echo data, partial echo data of an area corresponding to the position data of the another ship based on the position data of the ship and the position data of the another ship.

Further, a data collecting device according to another aspect of the present disclosure includes an acquiring part which acquires position data of a ship from a positioning device which generates the position data of the ship, an acquiring part which acquires echo data from a radar which receives a reflection wave of a radio wave transmitted around the ship and generates the echo data associated with a direction, an acquiring part which acquires travel data of an other ship from a communication device which receives the travel data of the other ship containing position data of the other ship, and a partially extracting part which extracts, from the echo data, partial echo data of an area corresponding to the position data of the another ship based on the position data of the ship and the position data of the another ship.

Further, a program according to another aspect of the present disclosure causes a computer to execute processing. The processing includes acquiring position data of a ship from a positioning device which generates the position data of the ship, acquiring echo data from a radar which receives a reflection wave of a radio wave transmitted around the ship and generates the echo data associated with a direction, acquiring travel data of an other ship from a communication device which receives the travel data of the other ship containing position data of the other ship, and extracting, from the echo data, partial echo data of an area corresponding to the position data of the another ship based on the position data of the ship and the position data of the another ship.

Further, a method of generating a machine learning model according to another aspect of the present disclosure includes generating, by a positioning device, position data of a ship, receiving, by a radar, a reflection wave of a radio wave transmitted around the ship, and generating, by the radar, echo data associated with a direction, receiving, by a communication device, travel data of an other ship containing position data of the other ship, extracting, from the echo data, partial echo data of an area corresponding to the position data of the another ship based on the position data of the ship and the position data of the another ship, and generating, by machine learning, a machine learning model for estimating a likelihood of a target object based on echo data, wherein the machine learning uses the partial echo data as input data and uses the existence of the target object as teaching data.

Further, a learning device according to another aspect of the present disclosure includes an acquiring part and a learning part. The acquiring part acquires a data set containing echo data generated by a radar which receives a reflection wave of a radio wave transmitted around a ship, and travel data of an other ship received by a communication device. The learning part generates, by machine learning, a machine learning model for estimating travel data of an other ship based on echo data, wherein the machine learning uses the echo data as input data and uses the travel data of the other ship as teaching data.

Further, a method of generating a machine learning model according to another aspect of the present disclosure includes acquiring a data set containing echo data generated by a radar which receives a reflection wave of a radio wave transmitted around a ship, and travel data of an other ship received by a communication device, and generating, by machine learning, a machine learning model for estimating travel data of an other ship based on echo data, wherein the machine learning uses the echo data as input data and uses the travel data of the other ship as teaching data.

Further, an estimating device according to another aspect of the present disclosure includes an acquiring part and an estimating part. The acquiring part acquires echo data generated by a radar which receives a reflection wave of a radio wave transmitted around a ship. The estimating part estimates travel data of an other ship based on the acquired echo data by using a machine learning model generated beforehand by machine learning, wherein the machine learning uses echo data as input data and uses travel data of an other ship as teaching data.

Further, a program according to another aspect of the present disclosure causes a computer to execute processing. The processing includes acquiring echo data generated by a radar which receives a reflection wave of a radio wave transmitted around a ship, and estimating travel data of an other ship based on the acquired echo data by using a machine learning model generated beforehand, wherein the machine learning uses echo data as input data and uses travel data of an other ship as teaching data.

### Effect of the Disclosure

According to the present disclosure, it becomes easier to collect the learning data.

### BRIEF DESCRIPTION OF DRAWINGS

FIG. 1 is a view illustrating one example of a configuration of a learning data collecting system according to this embodiment.

FIG. 2 is a view illustrating one example of echo data.

FIG. 3 is a view illustrating another example of the echo data.

FIG. 4 is a view illustrating one example of a procedure of a method of collecting learning data according to this embodiment.

FIG. 5 is a view illustrating an extraction of partial echo data.

FIG. 6 is a view illustrating one example of a storage database.

FIG. 7 is a view illustrating one example of a procedure of communication with a ground device.

FIG. 8 is a view illustrating one example of a learning data set.

FIG. 9 is a view illustrating a learning phase.

FIG. 10 is a view illustrating one example of a procedure of the learning phase.

FIG. 11 is a view illustrating another example of the learning data set.

FIG. 12 is a view illustrating still another example of the learning data set.

### MODE FOR CARRYING OUT THE DISCLOSURE

Hereinafter, one embodiment of the present disclosure is described with reference to the drawings.

### System Outline

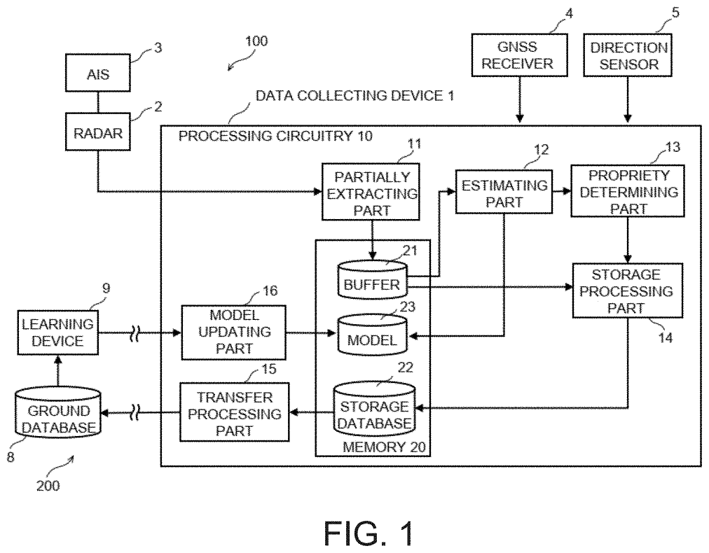

FIG. 1 is a view illustrating one example of a configuration of a learning data collecting system 100 according to this embodiment. The learning data collecting system 100 may be a system for collecting learning data used for learning a detection and identification model for detecting and identifying a target object from a radar echo.

The learning data collecting system 100 may be mounted on a ship (hereinafter, referred to as “the ship”), and collect the learning data in a period from a departure of the ship from a port until a return to the port. Further, the learning data collecting system 100 may transmit the collected learning data to a database 8 on the ground (ground DB), when the ship returns to the port.

A learning device 9 may learn the detection and identification model using the learning data stored in the ground DB 8. Note that the learning data collecting system 100, the ground DB 8, and the learning device 9 are collectively referred to as a “learning system 200.” The ground DB 8 and the learning device 9 are examples of external devices.

The learning data collecting system 100 may include a data collecting device 1, a radar 2, an AIS (Automatic Identification System) 3, a GNSS receiver 4, and a direction sensor 5.

The data collecting device 1 may be a computer including a CPU, a RAM, a ROM, a nonvolatile memory, an input/output interface, etc. The CPU of the data collecting device 1 may perform information processing according to a program loaded to the RAM from the ROM or the nonvolatile memory.

The program may be supplied, for example, via an information storage medium, such as an optical disc or a memory card, or may be supplied, for example, via a communication network, such as the Internet or a LAN.

The radar 2 may transmit a radio wave around the ship by an antenna and receives its reflection wave, and generate echo data based on the reception signal. The radar 2 may be installed so that its reference direction is in agreement with the heading of the ship.

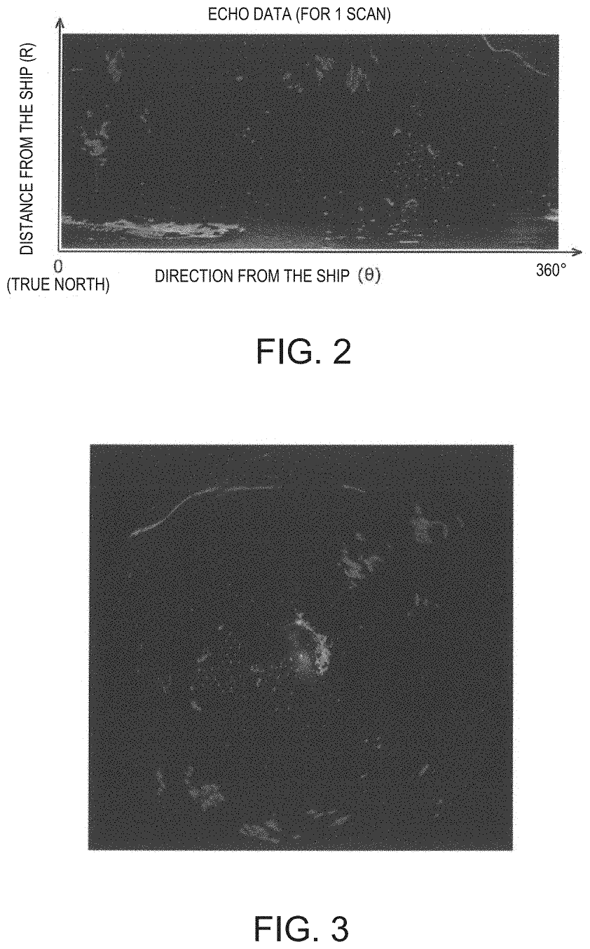

The echo data which is provided to the data collecting device 1 from the radar 2 may be R-θ data (so-called “raw data”) in which amplitude data is associated with R-θ coordinates represented by a direction (θ) and a distance (R) on the basis of the ship, for example, as illustrated in FIG. 2. Instead of the amplitude data, phase data may be associated therewith. Every time the antenna swivels for one revolution, echo data for one scan may be generated.

The direction (θ) of the echo data may be expressed by 0° to 360°, where the true north is 0°. The direction (θ) may be a direction (bearing or azimuth) detected by the direction sensor 5. That is, the direction detected by the direction sensor 5 may be associated with the echo data.

Without being limited to this configuration, the echo data may be display data after signal processing in which the R-θ data is converted into a circular shape centering on the ship (so-called “PPI display data”), for example, as illustrated in FIG. 3.

The AIS 3 may receive AIS data from other ships which exist around the ship, or a land control. The AIS 3 is one example of a communication device, and the AIS data is one example of travel data of another ship (another-ship travel data). The AIS data may contain data, such as the position, the heading or the bow direction, the course, the traveling speed, the ship length, the identification signal (MMSI) of another ship, for example. The position data of another ship may be represented by an absolute position (latitude and longitude). Instead of the AIS, a VDES (VHF Data Exchange System) may be used.

The GNSS receiver 4 may generate the position data of the ship based on the radio wave received from the GNSS (Global Navigation Satellite System). The GNSS receiver 4 is one example of a positioning device. The position data of the ship may be represented by an absolute position (latitude and longitude).

The direction sensor 5 may detect the direction of the ship. Like the radar 2, the direction sensor 5 may be installed so that its reference direction is in agreement with the heading or the bow direction. The direction sensor 5 may be a GPS compass, a magnetic compass, or a gyrocompass, for example.

The data collecting device 1 may include a partially extracting part 11, an estimating part 12, a propriety determining part 13, a storage processing part 14, a transfer processing part 15, and a model updating part 16. These functional parts (i.e., processing circuitry 10) may be implemented by the CPU of the data collecting device 1 performing the information processing according to the program.

The data collecting device 1 may further include a buffer memory 21, a storage database 22, and a model memory 23. These memory parts (i.e., a memory 20) may be provided to the nonvolatile memory of the data collecting device 1. A part of the functional parts or the memory parts may be provided to an apparatus which is exterior of the data collecting device 1.

### Collection of Learned Data

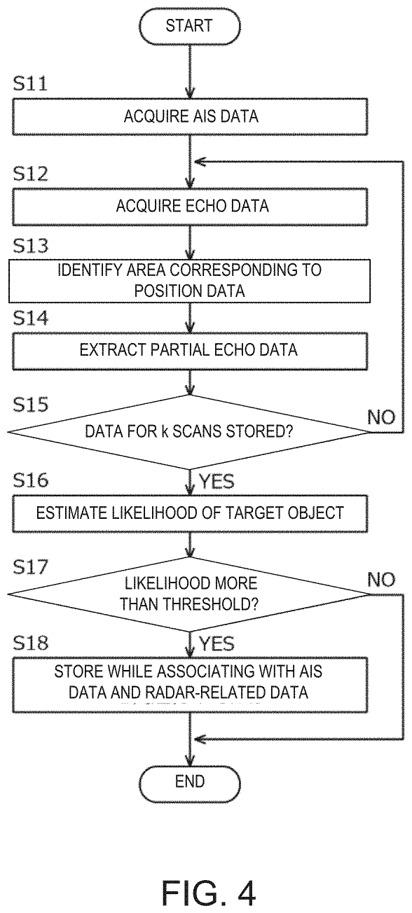

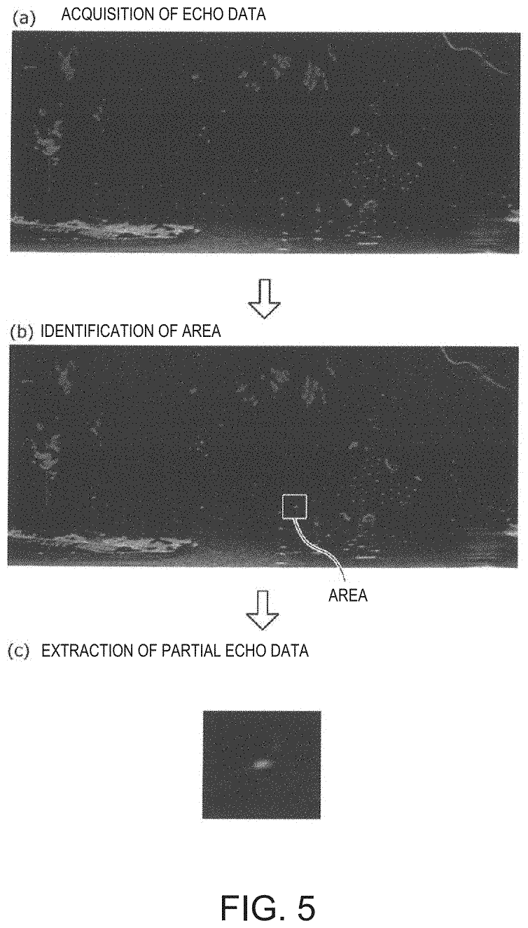

FIG. 4 is a view illustrating one example of a procedure of the method of collecting learning data according to this embodiment, which is realized in the learning data collecting system 100. The CPU of the data collecting device 1 may perform the information processing illustrated in this drawing according to the program. FIG. 5 is a view illustrating an extraction of partial echo data.

First, the data collecting device 1 may acquire the AIS data from the AIS 3, and acquire the echo data from the radar 2 (S11, S12: processing as an acquiring part).

Next, the data collecting device 1 may identify an area corresponding to the position data of another ship of the AIS data in the echo data, based on the position data of the ship and the position data of another ship, and extract partial echo data of the identified area from the echo data (S13, S14: processing as the partially extracting part 11; see FIG. 5). Here, by calculating the distance (R) and the direction (θ) of another ship on the basis of the ship based on the absolute positions (latitudes and longitudes) of the ship and another ship, the position in the echo data associated with the direction may be identified. The area may be a rectangular area which includes a location indicated by the position data of another ship at the center, for example. The extracted partial echo data may be stored in the buffer memory 21.

The data collecting device 1 may extract the partial echo data from the echo data, every time the radar 2 generates the echo data for one scan. Thus, the partial echo data for a plurality of scans may be stored in the buffer memory 21 per AIS data.

When the partial echo data for k scans are stored in the buffer memory 21 (S15: YES), the data collecting device 1 may use the machine learning model stored in the model memory 23 to estimate a likelihood of the target object based on the partial echo data for k scans, and determine whether the likelihood is more than a threshold (S16, S17: processing as the estimating part 12 and the propriety determining part 13). By this processing, it may be determined whether the partial echo data is suitable as the learning data. Note that k may be a natural number.

The machine learning model may be a model which is generated beforehand by machine learning by using the echo data as input data and using the existence of the target object as teaching data. The machine learning model may be a detection and identification model, such as an SSD (Single Shot MultiBox Detector), a YOLO (You Only Look Once), or a Faster R-CNN, for example. Without being limited to this configuration, an identification model which only performs identification of the target object may be used. The machine learning model may be configured to output the likelihood of the identified target object by a Softmax function provided to the output layer.

Next, the data collecting device 1 may acquire, from the buffer memory 21, the partial echo data for k scans of which the likelihood of the target object is determined to be more than the threshold, and may store them in the storage DB 22, while associating them with the AIS data and the radar-related data (S18: processing as the storage processing part 14). The storage processing part 14 is one example of an associating part.

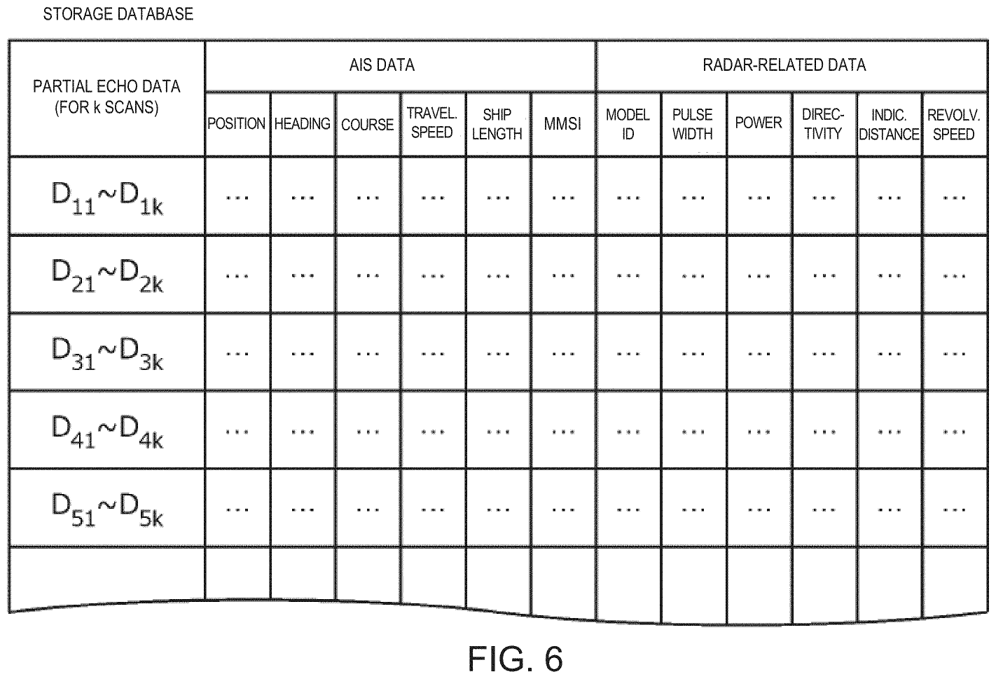

FIG. 6 is a view illustrating one example of the storage DB 22. In the storage DB 22, the AIS data and the radar-related data may be associated with the partial echo data. The AIS data may contain data, such as the position, the heading or the bow direction, the course, the traveling speed, the ship length, and the identification signal of another ship, for example. The radar-related data may contain data, such as a model, a pulse width, power, directivity, indication distance, and revolving speed of the radar, for example. Note that “k” in each line of the partial echo data may be a natural number different from others. Further, the data such as the position of another ship which is stored in the storage DB 22 may be relative information with respect to the ship, without being limited to the absolute information.

The procedure of the method of collecting the learning data may be finished as described above.

According to this embodiment, since the partial echo data of the area corresponding to the position data of the AIS data is extracted from the echo data, it becomes easier to collect the learning data. Especially, it is possible to collect useful learning data and to reduce the amount of data. Further, since the partial echo data is stored so as to be associated with the AIS data and the radar-related data, it becomes further easier to collect the learning data.

Moreover, since the partial echo data of which the likelihood of the target object is more than the threshold, which is suitable for the learning data, is stored, it is possible to collect more useful learning data. Further, since the likelihood of the target object is estimated from the partial echo data for k scans obtained for one AIS data, it is possible to improve the estimation accuracy.

Note that, the shape or the size of the area extracted at S12 and S13 described above may be changed according to the AIS data or the radar-related data. For example, the area may be extended in the bow direction or the heading contained in the AIS data, or the area may be enlarged as the traveling speed, the turning round speed, or the ship length becomes larger. Further, the area may be extended in the 0 direction as the directivity (antenna width) or the revolving speed of the antenna contained in the radar-related data becomes higher.

Communication with Ground Device

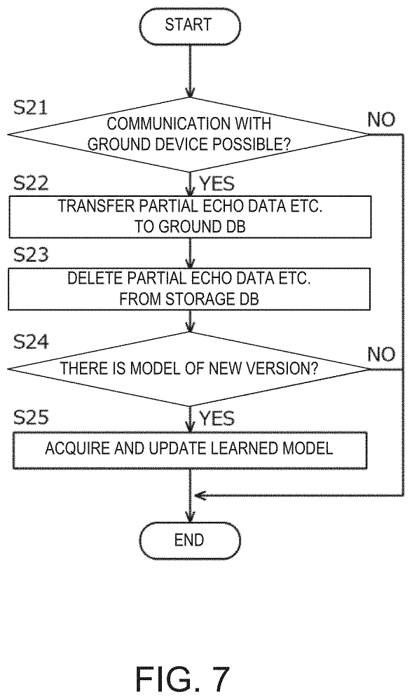

Below, communication with the ground DB 8 and the learning device 9, which are provided on the ground, which is performed when the ship carrying the learning data collecting system 100 (i.e., “the ship” as described above) returns to a port is described. FIG. 7 is a view illustrating one example of a procedure of communication with the ground DB 8 and the learning device 9. The CPU of the data collecting device 1 may perform information processing illustrated in this drawing according to the program.

First, if wired or wireless communication with the ground DB 8 becomes possible (S21: YES), the data collecting device 1 may transfer to the ground DB 8 the partial echo data accumulated in the storage DB 22, and the AIS data and the radar-related data (see FIG. 6) which are associated with the partial echo data (S22: processing as the transfer processing part 15), and delete from the storage DB 22 the partial echo data of which the transfer has been finished to create some space (S23).

Next, if there is the machine learning model of the new version generated by the learning device 9 (S24: YES), the data collecting device 1 may acquire the machine learning model of the new version from the learning device 9, and store it in the model memory 23 (S25: processing as the model updating part 16). In detail, the machine learning model stored in the model memory 23 may be replaced by the machine learning model of the new version.

The procedure of communication with the ground DB 8 and the learning device 9 may be finished as described above.

According to this embodiment, since the transfer of the partial echo data etc. is performed when the ship returns to the port and establishes communication with the ground DB 8, the extraction of the learning data becomes easier. Especially, in this embodiment, since the amount of data is reduced by extracting the partial echo data, a quick extraction of the learning data is possible.

Further, the learning device 9 may use the useful learning data stored in the ground DB 8 to perform relearning and update the machine learning model, and the data collecting device 1 may use the updated machine learning model to collect the still more useful learning data. By repeating this cycle, it becomes possible to continuously improve the machine learning model.

Further, by updating the machine learning model using the learning data collected parallelly from a plurality of ships, it becomes possible to more efficiently improve the machine learning model. Moreover, the machine learning model may be generated for every model of radar, using the model of radar contained in the radar-related data.

### Learning Phase

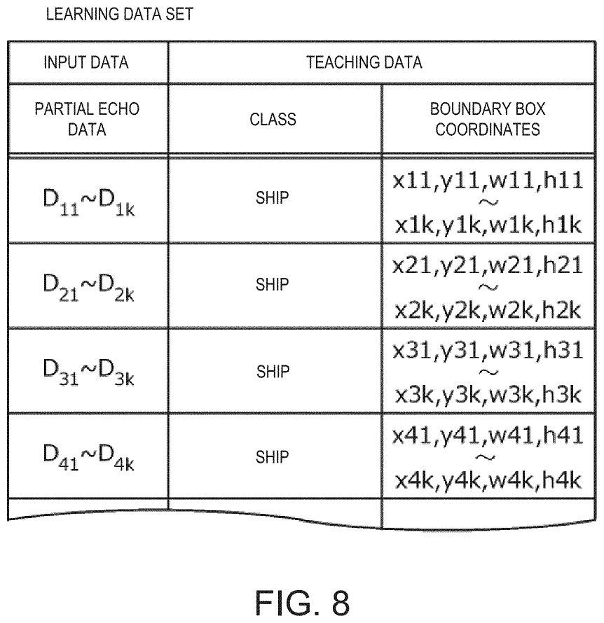

Below, a method of generating the machine learning model according to this embodiment, which is implemented in the learning device 9 of the learning system 200, is described. FIG. 8 is a view illustrating one example of a learning data set used for the learning phase in which the machine learning model is generated. The learning data set may contain input data and teaching data.

The input data may be the partial echo data which is collected by the data collecting device 1 described above and is transferred to the ground DB 8. The input data may contain normal echo data, without being limited to the partial echo data.

The teaching data may include the class of the target object which appears in the partial echo data, and coordinates of a boundary box including the target object. When the input data is the partial echo data which extracts from the echo data the area corresponding to the position data of the AIS data, the setup of the coordinates of the boundary box is easier because the coordinates of the boundary box may be set as the entire partial echo data.

The class of the target object may be a ship. Without being limited to this configuration, the class of the target object may be divided into classes related to the ship size, such as a small ship, a medium-size ship, a large ship, or a super-large ship, by utilizing the identification signal of the AIS data associated with the partial echo data, or may be divided into classes related to the ship type, such as a pleasure boat, a fishing boat, a merchant ship, or a tanker.

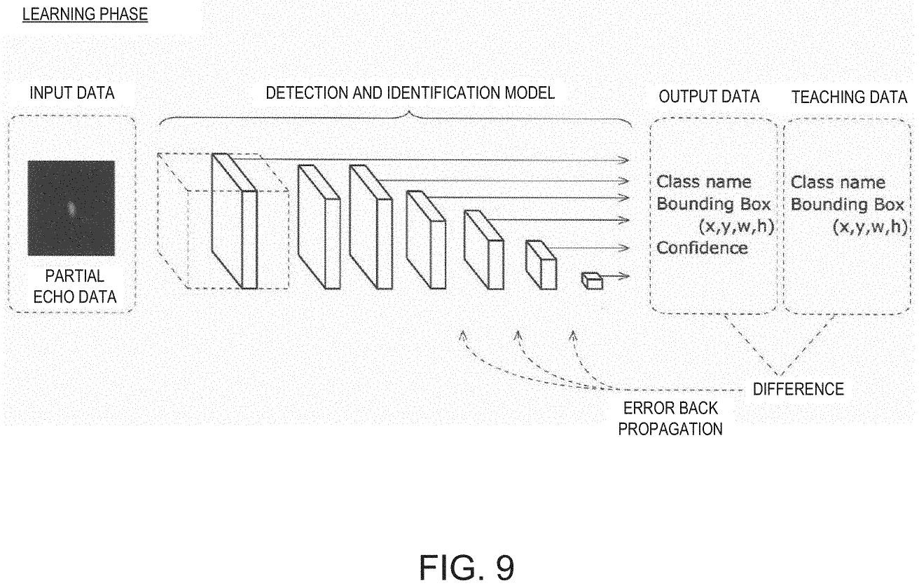

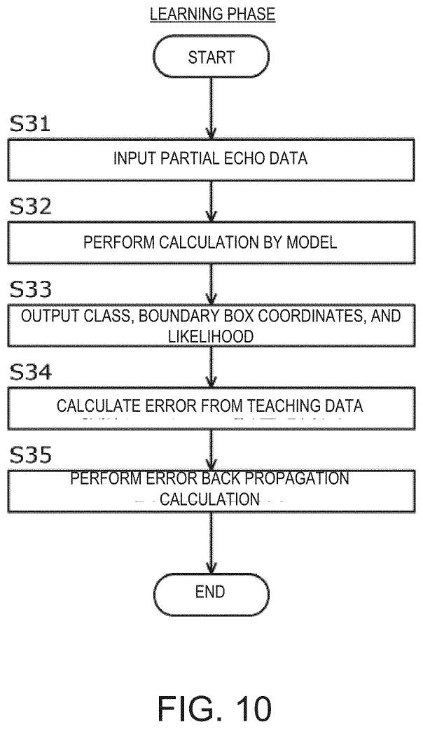

FIG. 9 is a view illustrating the learning phase. FIG. 10 is a view illustrating one example of a procedure of the learning phase. The CPU of the learning device 9 may perform information processing illustrated in this drawing according to the program.

In this embodiment, the detection and identification model, such as the SSD (Single Shot MultiBox Detector), may be used, for example. Elements, such as the class (Classname), coordinates of the boundary box (Bounding Box (x, y, w, h)), and the likelihood (Confidence), may be provided to the output layer of the detection and identification model. A Softmax function may be used for the likelihood element.

First, the learning device 9 may use the partial echo data contained in the learning data set as the input data and input it into the detection and identification model (S31), perform a calculation by the detection and identification model (S32), and output the class, the coordinates of the boundary box, and the likelihood as the output data (S33).

Next, the learning device 9 may calculate a difference between the class and the coordinates of the boundary box as the teaching data contained in the learning data set, and the class and the coordinates of the boundary box as the output data (S34), and perform an error back propagation calculation (S35).

Thus, a learned detection and identification model for estimating the class, the coordinates of the boundary box, and the likelihood of the target object may be generated from the echo data.

Note that the learning data set may be modified as follows.

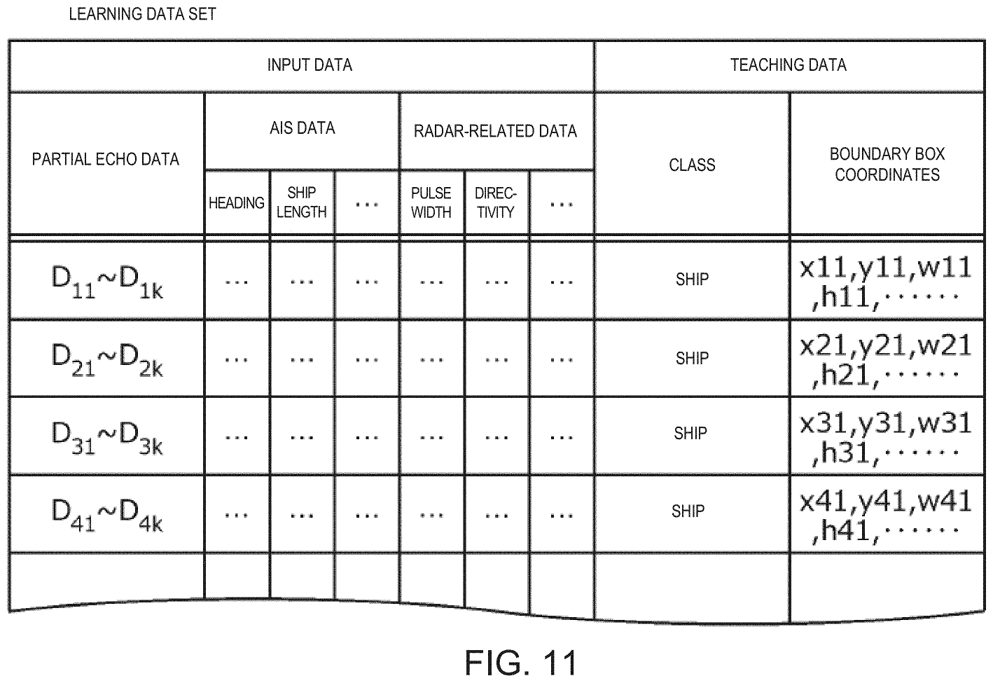

FIG. 11 is a view illustrating another example of the learning data set. In this example, the input data of the learning data set may further contain the AIS data and the radar-related data which are associated with the partial echo data by the data collecting device 1 described above.

Thus, the detection and identification model of this example may be configured so that the class, the coordinates of the boundary box, and the likelihood of the target object are estimated using the AIS data and the radar-related data in addition to the partial echo data. Therefore, it is possible to further improve the estimation accuracy.

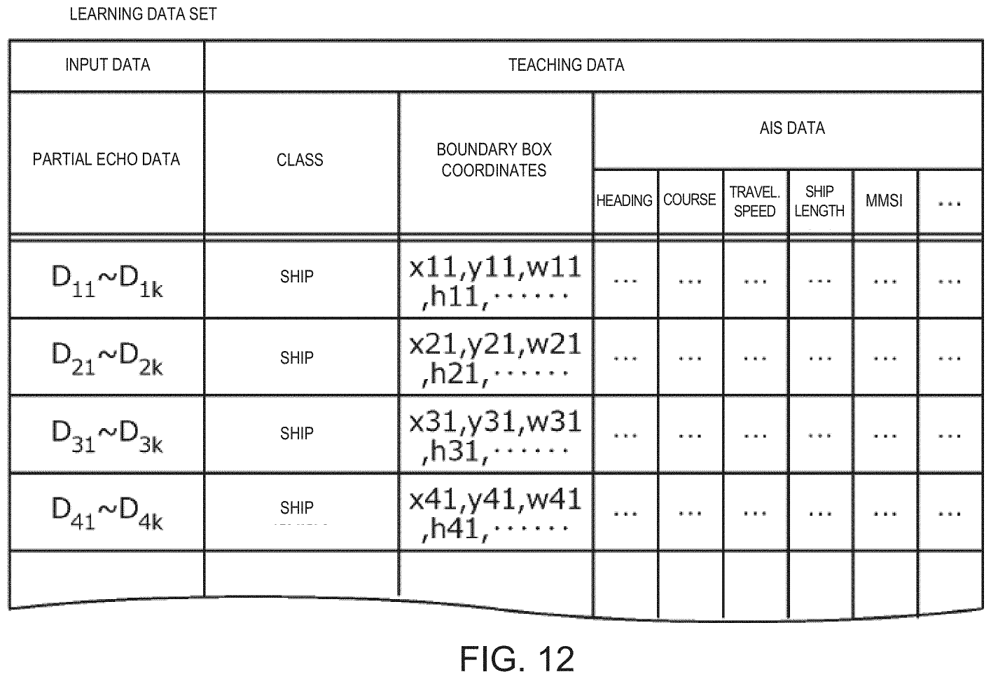

FIG. 12 is a view illustrating still another example of the learning data set. In this example, the teaching data of the learning data set may further contain the AIS data which is associated with the partial echo data by the data collecting device 1 described above. In detail, the teaching data may contain some of the AIS data, for example, the heading, the course, the traveling speed, the ship length, and the identification signal.

Thus, the detection and identification model of this example may be configured so as to estimate the AIS data corresponding to the teaching data in addition to the class, the coordinates of the boundary box, and the likelihood.

Thus, it becomes possible to obtain the AIS data from the echo data for another ship which does not transmit the AIS data. Further, it also becomes possible to obtain the AIS data from the echo data if the ship does not carry the AIS.

As described above, the embodiment of the present disclosure is explained, but the present disclosure is not limited to the embodiment described above, and it is needless to say that various changes are possible for the person skilled in the art.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### DESCRIPTION OF REFERENCE CHARACTERS

1 Data Collecting Device
2 Radar
3 AIS
4 GNSS Receiver
5 Direction Sensor
11 Partially Extracting Part
12 Estimating Part
13 Propriety Determining Part
14 Storage Processing Part
15 Transfer Processing Part
16 Model Updating Part
21 Buffer Memory
22 Storage Database
23 Model Memory
8 Ground Database
9 Learning Device
100 Learning Data Collecting System
200 Learning System

What is claimed is:

1. A learning data collecting system, comprising:
a positioning device configured to generate position data of a ship;
a radar configured to receive a reflection wave of a radio wave transmitted around the ship and generate echo data associated with a direction;
a communication device configured to receive travel data of an other ship, the travel data containing position data of the other ship; and
processing circuitry configured to extract, from the echo data, partial echo data of an area corresponding to the position data of the other ship based on the position data of the ship and the position data of the other ship.

2. The learning data collecting system of claim 1, wherein the processing circuitry is further configured to associate the travel data of the other ship with the partial echo data.

3. The learning data collecting system of claim 1, wherein the processing circuitry is further configured to associate radar-related data related to the radar with the partial echo data.

4. The learning data collecting system of claim 1, wherein the processing circuitry is further configured to determine the propriety of the partial echo data as learning data.

5. The learning data collecting system of claim 4, wherein
the processing circuitry implements a machine learning model trained on echo data as input data and a presence of a target object as teaching data, and
the processing circuitry estimates a likelihood of the presence of the target object based on the partial echo data and determines the propriety of the partial echo data according to the likelihood.

6. The learning data collecting system of claim 5, wherein the processing circuitry estimates the likelihood of the presence of the target object based on a plurality of time-series partial echo data acquired from the travel data of the other ship.

7. The learning data collecting system of claim 1, wherein the processing circuitry is further configured to transfer to an external device the partial echo data accumulated in a memory.

8. The learning data collecting system of claim 5, wherein the processing circuitry is further configured to replace the machine learning model stored in a memory with a machine learning model provided from an external device.

9. The learning data collecting system of claim 1, wherein the processing circuitry changes the shape or the size of the area according to the travel data of the other ship or radar-related data.

10. The learning data collecting system of claim 1, wherein
the processing circuitry is further configured to detect a direction of the ship via a direction sensor, and
the radar associates the direction detected by the direction sensor with the echo data.

11. A method of collecting learning data, comprising the steps of:
generating, by a positioning device, position data of a ship;
receiving, by a radar, a reflection wave of a radio wave transmitted around the ship, and generating, by the radar, echo data associated with a direction;
receiving, by a communication device, travel data of an other ship containing position data of the other ship; and
extracting, from the echo data, partial echo data of an area corresponding to the position data of the other ship based on the position data of the ship and the position data of the other ship.

12. An estimating device, comprising:
processing circuitry configured to:
acquire echo data generated by a radar configured to receive a reflection wave of a radio wave transmitted around a ship, and
estimate travel data of an other ship based on the acquired echo data by implementing a machine learning model, wherein the machine learning model is trained on echo data as input data and travel data from the other ship as teaching data.
